(19) United States
(12) Patent Application Publication
(10) Pub. No.: US 2024/0264796 A1
(43) Pub. Date: Aug. 8, 2024

(54) CONTROL AND CONFIGURATION FOR WIRELESS AUDIO DEVICES

(71) Applicant: INTERNATIONAL BUSINESS MACHINES CORPORATION, ARMONK, NY (US)

(72) Inventors: Adam Lee Davenport, Las Vegas, NV (US); Derek Brewer, Bowling Green, OH (US); Robert Wilhelm, Cheyenne, WY (US); Steven Perrotta, Washington, DC (US)

(21) Appl. No.: 18/165,517

(22) Filed: Feb. 7, 2023

(51) Int. Cl. G06F 3/16; H04L 9/40; H04R 3/00

(52) U.S. Cl. CPC G06F 3/165; H04L 63/10; H04R 3/00; H04R 2420/07

(57) ABSTRACT

According to one embodiment, a method, computer system, and computer program product for transmitting data from a set of edge devices is provided. The embodiment may include identifying one or more Internet-of-Things (IoT) devices within a structure. The embodiment may include combining the identified one or more IoT devices into one or more groups. The embodiment may include identifying a respective primary device for each group of the one or more groups. The embodiment may include deploying a tiny machine learning (ML) model on each identified respective primary device. In response to detection of an event within the structure by a group of the one or more groups, the embodiment may include utilizing the tiny ML model of a primary device of the group to select one or more other groups for activation.

### BACKGROUND

The present invention relates generally to the field of computing, and more particularly to wireless audio devices.

Wireless audio devices include wireless speakers which are loudspeakers that receive audio signals using radio frequency (RF) waves rather than over audio cables. The two most common RF frequencies that support audio transmission to wireless speakers include Wi-Fi and Bluetooth to transmit audio data to a receiving speaker. In a common scenario, a smart device (e.g., a smartphone, a smart speaker) may be paired to one or more wireless speakers and serve as the source for music that will be played through the one or more wireless speakers. Further, a user of the smart device may control playback operation of the one or more wireless speakers via the smart device. In another scenario, a wireless speaker itself may be enabled as a smart device. A smart device is an electronic device that may connect, share information, and interact with its user and other smart devices. Smart devices generally connect to other devices or networks via different wireless protocols (e.g., Bluetooth, Zigbee, Near-Field Communication (NFC), Wi-Fi, and cellular networks) and may operate to some extent interactively and autonomously. Smart devices and wireless speakers play a fundamental role in today's commercial electronic industry and are at the center of the Internet-of-Things (IoT).

### SUMMARY

According to one embodiment, a method, computer system, and computer program product for controlling a wireless audio device is provided. The embodiment may include connecting to the wireless audio device via a smart device of a non-owner user of the wireless audio device. The wireless audio device operates according to a plurality of control profiles. In response to determining that an identification (ID) the smart device correlates to a user-specific secondary control profile of the plurality of control profiles, the embodiment may include enabling operation of the wireless audio device by the smart device according to the user-specific secondary control profile. In response to determining that the ID of the smart device does not correlate to any user-specific secondary control profiles of the plurality of control profiles, the embodiment may include enabling operation of the wireless audio device by the smart device according to a default secondary control profile of the plurality of control profiles.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for defining operation control profiles for a wireless speaker via an initial wireless audio device setup process according to at least one embodiment.

FIG. 3 illustrates an operational flowchart for configuring operation of a wireless speaker by a user via a wireless audio device operation process according to at least one embodiment.

FIG. 4 illustrates an operational flowchart for requesting a change to correlated wireless speaker settings of a user via a wireless audio device settings change request process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to wireless audio devices. The following described exemplary embodiments provide a system, method, and program product to, among other things, configure and enforce restrictive controls on wireless audio device operation. Therefore, the present embodiment has the capacity to improve the technical field of wireless audio devices by dynamically configuring settings and permissible uses of a wireless audio device, or a group of wireless audio devices, thus reducing unpermitted use of the wireless audio device and mitigating the potential for damage to the wireless audio device resulting from operation with undesired settings.

As previously described, wireless audio devices include wireless speakers which are loudspeakers that receive audio signals using RF waves rather than over audio cables. The two most common RF frequencies that support audio transmission to wireless speakers include Wi-Fi and Bluetooth to transmit audio data to a receiving speaker. In a common scenario, a smart device (e.g., a smartphone, a smart speaker) may be paired to one or more wireless speakers and serve as the source for music that will be played through the one or more wireless speakers. Further, a user of the smart device may control playback operation of the one or more wireless speakers via the smart device. In another scenario, a wireless speaker itself may be enabled as a smart device. A smart device is an electronic device that may connect, share information, and interact with its user and other smart devices. Smart devices generally connect to other devices or networks via different wireless protocols (e.g., Bluetooth, Zigbee, NFC, Wi-Fi, and cellular networks) and may operate to some extent interactively and autonomously. Smart devices and wireless speakers play a fundamental role in today's commercial electronic industry and are at the center of the IoT.

As mentioned above, an authorized smart device may allow a user to control operation of a wireless speaker device. However, current controls typically only include methods by which a user may connect (e.g., entering a passcode, controlling discoverability of the device) to the wireless speaker device or implement broad volume restrictions, they do not provide more granular controls such as, but not limited to, limiting device volume, configuring device equalizer settings, limiting device usage to specific hours, dynamic and static content filtering of streamed music, or a combination thereof. Considering the high cost of many commercially available wireless speaker devices, such granular control may be a valuable addition to usability in order to prevent possible damage to components of a wireless speaker device by being played at a high volume or according to certain equalizer settings, as well as to prevent unauthorized/unpermitted use of the wireless speaker device. It may therefore be imperative to have a system in place to control access to a wireless speaker device via association and identification of an authorized controlling smart device and dynamically implement controls for various settings of the wireless speaker device based on identification of the controlling smart device. Thus, embodiments of the present invention may be advantageous to, among other things, authenticate and authorize connection to a wireless speaker via a controlling smart device, create one or more user profiles which define usage restrictions of a wireless speaker based on identification of a correlated controlling smart device, dynamically define one or more maximum allowable volumes and/or equalizer settings for a wireless speaker based on different usage contexts (e.g., identification of a controlling smart device), limit use of a wireless speaker to defined time periods based on identification of a controlling smart device, perform dynamic and/or static filtering of audio content played/streamed on a wireless speaker based on identification of a controlling smart device, and facilitate modification of a user profile by an owning user/device of a wireless speaker. The present invention does not require that all advantages need to be incorporated into every embodiment of the invention.

According to at least one embodiment, an initial setup of a wireless speaker may be performed by a user via a controlling smart device (e.g., a smartphone) or a controlling computer upon connection to the wireless speaker. Typically, the user performing the initial setup may be an owner of the wireless speaker or a user with unrestricted use (i.e., an administrative user) of the wireless speaker. During the initial setup, the user may create a primary control profile which correlates to their controlling smart device or computer, and which defines a plurality of restrictive operation controls for the wireless speaker and whether any of the restrictive operation controls are to be enabled for their controlling device. Additionally, the owning/administrative user may further create one or more default and manually configured secondary control profiles to correlate with controlling devices of other users (i.e., non-owning and non-administrative users) upon connection to the wireless speaker. The one or more default and manually configured secondary control profiles may define values for the plurality of restrictive operation controls for the wireless speaker. According to at least one other embodiment, after an initial setup of a wireless speaker has been performed, a determination may be made as to whether a controlling device of a non-owning or non-administrative user is correlated with a default or manually configured secondary control profile upon connection of the controlling device to the wireless speaker. The connected controlling device may then operate the wireless speaker according to its correlated secondary control profile. According to at least one further embodiment, a non-owning or non-administrative user may request a change to a secondary control profile correlated with their controlling smart device. An owning or administrative user may grant the requested change and the secondary control profile for the non-owning or non-administrative user may be updated accordingly.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to define user specific operational limits of a wireless audio device and, accordingly, allow operation of the wireless audio device by a user according to their respectively defined operational limits.

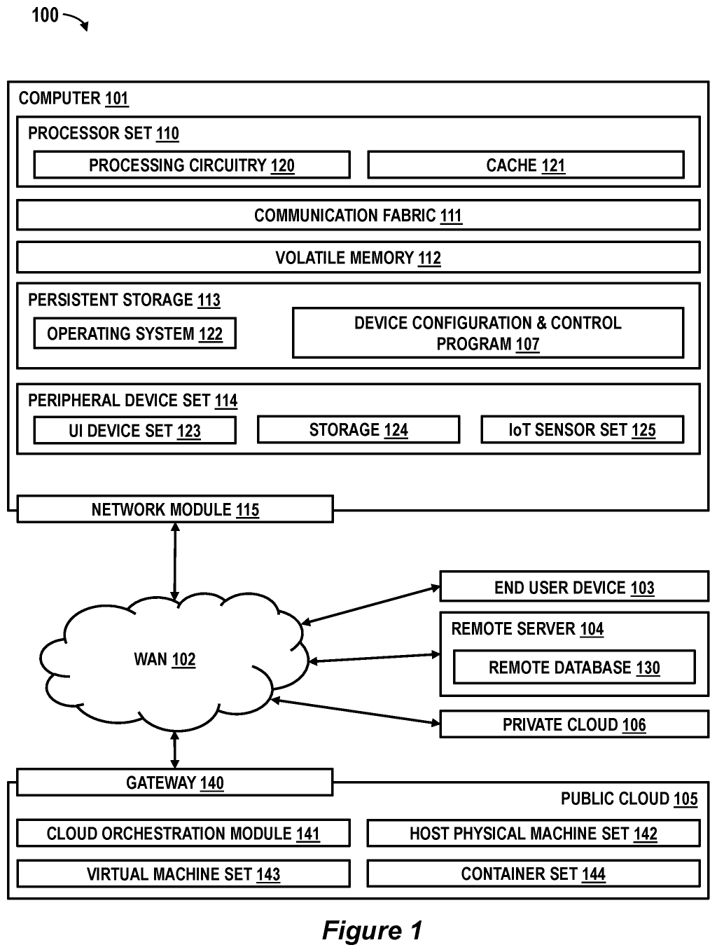

Referring to FIG. 1, an exemplary computing environment 100 is depicted, according to at least one embodiment. Computing environment 100 contains an example of an environment for the execution of at least some of the computer code involved in performing the inventive methods, such as device configuration and control (DCC) program 107. In addition to DCC program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and DCC program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. Additionally, computer 101 may be any other form of computer or mobile device now known or to be developed in the future that is AR/VR-enabled. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in DCC program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in DCC program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be a wireless audio device (e.g., a wireless speaker) or a smart device (e.g., a smart tv) capable of connecting to computer 101 via WAN 102 and network module 115 and capable of receiving operation instructions from DCC program 107.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

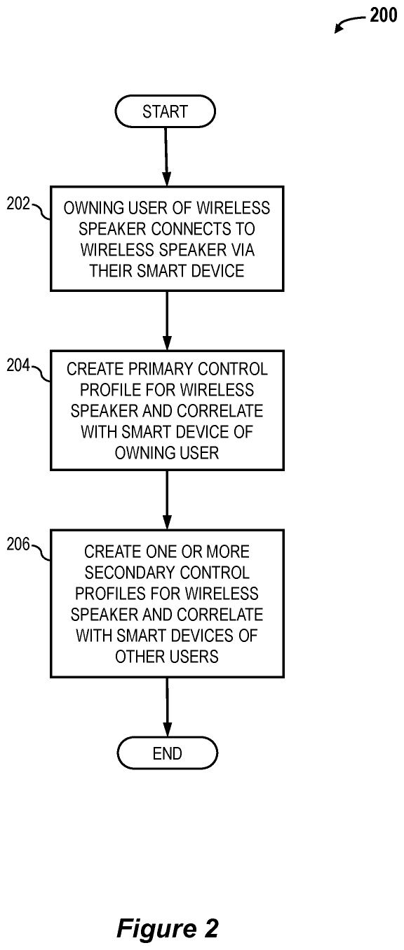

The DCC program 107 may be a program capable of enabling and disabling connection to a wireless audio device, authenticating connection to a wireless audio device via a smart device of a user, controlling a maximum allowable volume of a wireless audio device, controlling equalizer settings of a wireless audio device, filtering audio data played/streamed on a wireless audio device based on information of the audio data, configuring user specific operational controls and filters of a wireless audio device, correlating configured controls and filters of a wireless audio device with a controlling smart device of a user based on identification of the user, enabling changes to configured controls and filters of a wireless audio device which are correlated with a smart device of a user, and disabling operation of a wireless audio device in response to a lack of authentication with a connected smart device. In at least one embodiment, DCC program 107 may require a user to opt-in to system usage upon opening or installation of DCC program 107 or upon connecting to a wireless audio device managed by DCC program 107. Notwithstanding depiction in computer 101, DCC program 107 may be stored in and/or executed by, individually or in any combination, end user device 103, remote server 104, public cloud 105, and private cloud 106 so that functionality may be separated among the devices. The wireless audio device configuration and control method is explained in further detail below with respect to FIGS. 2, 3, and 4.

Referring now to FIG. 2, an operational flowchart for defining operation control profiles for a wireless speaker via an initial wireless audio device setup process 200 is depicted according to at least one embodiment. At 202, an initial setup of a wireless audio device, such as a wireless speaker, for management by DCC program 107 begins with an owner, or administrative user, of the wireless speaker (e.g., EUD 103) connecting to the wireless speaker via a smart device (e.g., computer 101), such as their smartphone, which they intend to use to control operation of the wireless speaker. The owner of the wireless speaker may have installed DCC program 107 on their smartphone prior to connecting to the wireless speaker.

Alternatively, the owner of the wireless speaker may be prompted to install DCC program 107 on their smartphone and accept wireless audio device management by DCC program 107 upon initial connection to the wireless speaker. Connection between the smartphone of the owner and the wireless speaker may be implemented via a wireless connectivity protocol such as Z-wave, Bluetooth, or Wi-Fi.

Next, at 204, the owner or administrative user of the wireless speaker utilizes DCC program 107 to create a primary control profile for the wireless speaker and correlate the created primary control profile with their smart device (i.e., the smartphone). The primary control profile may define a plurality of parameters, and corresponding values, according to which the wireless speaker may operate. For example, the primary control profile may include parameters, with corresponding values, for profile name/type, smart device identification (ID), smart device authority level, audio device maximum volume, audio device maximum bass, audio device maximum treble, audio device maximum mid-range, audio device operating hours, operating hours maximum volume, dynamic lyric lookup, deny list capability, and deny list contents. The foregoing parameters are provided as examples and are not meant to limit the parameters which may be included in a primary control profile; other similar parameters may be included (e.g., allowable operation days, dynamic equalizer adjustment). An example primary control profile is depicted in Table 1 below:

TABLE 1

| PARAMETER | VALUE |
|---|---|
| Profile Name/Type | owner |
| Smart Device ID | smartdevice1234 |
| Smart Device Authority Level | primary |
| Audio Device Maximum Volume | unlimited |
| Audio Device Maximum Bass | unlimited |
| Audio Device Maximum Treble | unlimited |
| Audio Device Maximum Mid-Range | unlimited |
| Audio Device Operating Hours | all |
| Operating Hours Maximum Volume | unlimited |
| Dynamic Lyric Lookup | off |
| Deny List Capability | off |
| Deny List Contents | null |

As can be seen in Table 1, the primary control profile may define the profile name/type as being an owner profile, identify the smart phone of the owner or administrative user by some specific ID (e.g., smartdevice1234) of the smart phone, set an authority level of the smart phone to primary (i.e., a highest level of authority having ability to change parameter values), set unrestricted (i.e., unlimited) values for maximum volume, bass, treble, and mid-range of the wireless speaker, allow for all hours of operation, and disable dynamic lyric lookup and deny list capability. It should be noted that although the example primary control profile of Table 1 allows for unrestricted use of the wireless speaker by the owner or administrative user via their smartphone, the owner or administrative user could set, via DCC program 107, one or more operation limits on their use of the wireless speaker (e.g., maximum volume restrictions or set operation hours).

As noted above and continuing with 204, DCC program 107 also correlates the created primary control profile with the smartphone of the owner or administrative user. DCC program 107 may do so by correlating the smart device ID of the smartphone with the profile name/type. Furthermore, DCC program 107 may store the created primary control profile within storage 124 or remote database 130. According to at least one embodiment, upon subsequent connections to the wireless speaker by the owner or administrative user via their smartphone, DCC program 107 may retrieve the correlated primary control profile from storage 124 or remote database 130 and operate the wireless speaker accordingly. According to at least one other embodiment, the owner or administrative user may create, via DCC program 107, one or more additional primary control profiles which correlate to respective one or more smart devices of other owner or administrative users.

At 206, the owner or administrative user of the wireless speaker utilizes DCC program 107 to create one or more secondary control profiles for the wireless speaker and correlate created secondary control profiles with respective smart devices (i.e., smartphones) of other users (i.e., non-owning or non-administrative users) of the wireless speaker. The created one or more secondary control profiles may include a default secondary control profile and one or more user-specific secondary control profiles for the wireless speaker. A secondary control profile may include parameters similar to the primary control profile, however parameters of a secondary control profile are likely to have corresponding values which place one or more restrictions on the operation of the wireless speaker. For example, a secondary control profile may be subject to limitations on a maximum volume at which the wireless speaker may be operated, limitations on maximum bass, treble, and/or mid-range values for the wireless speaker, limitations on operating hours of the wireless speaker (as well as potential volume limitations during operating hours), and/or limitations on allowable content played/streamed by the wireless speaker based on content information such as dynamic lyric lookup, artist, genre, and title. An example of the default secondary control profile for a non-owning or non-administrative user is depicted in Table 2 below:

TABLE 2

| PARAMETER | VALUE |
|---|---|
| Profile Name/Type | default |
| Smart Device ID | unknown |
| Smart Device Authority Level | secondary |
| Audio Device Maximum Volume | 60% |
| Audio Device Maximum Bass | 50% |
| Audio Device Maximum Treble | 50% |
| Audio Device Maximum Mid-Range | 50% |
| Audio Device Operating Hours | 6:00am-8:00pm |
| Operating Hours Maximum Volume | 6:00pm-8:00pm \| 40% |
| Dynamic Lyric Lookup | on |
| Deny List Capability | on |
| Deny List Contents | artist: some-band; |
| | lyrics: explicit |

As can be seen in Table 2, the default secondary control profile may define the profile name/type as being a default profile, identify a smart phone of the non-owning or non-administrative user as unknown, set an authority level of the smart phone to secondary (i.e., a level of authority lacking ability to change parameter values), limit maximum volume of the wireless speaker to 60%, limit maximum values for bass, treble, and mid-range of the wireless speaker to 50%, limit operating hours of the wireless speaker (and further limit the maximum volume during a subset of the operating hours), enable dynamic lyric lookup, and enable deny list capability based on deny list contents. With this profile in place, any smart device which is unknown (i.e., smart device ID is unknown) to DCC program 107 but connects to the wireless speaker may be correlated with the default secondary control profile and have the restrictions of Table 2 enforced during operation of the wireless speaker. According to at least one embodiment, the owner or administrative user of the wireless audio device may create one or more default secondary control profiles which define profile parameters to be enforced within respective areas.

According to at least one embodiment, dynamic lyric lookup of content (e.g., a song track) played/streamed, or to be played/streamed, on the wireless speaker may be achieved by DCC program 107 querying a known source of song track information (e.g., a third-party database of song tracks or an online music streaming service) or the internet for lyrics of a next song as well as for metadata information of the next song (e.g., song title, artist name, song genre, and any parental advisory label (PAL) notices for the song), and determining if the song meets any criteria to not be played/streamed on the wireless speaker. The criteria may be defined by the owning or administrative user who may enable deny list capability of a control profile (primary or secondary) and may preconfigure deny list contents to include a list of song titles, artists, and/or genres in order to prevent the playback of those listed song titles, songs from those listed artists, and/or songs of those listed genres. The criteria may also include default rules defining when deny list capability of a control profile should be dynamically enabled and when a song should be restricted from playback. For example, when dynamic lyric lookup is enabled in either a primary or secondary control profile, DCC program 107 may automatically enable deny list capability within the profile and add metadata information of a next song track (e.g., song title) to deny list contents of the profile in response to determining that the next song track contains explicit lyrics or in response to determining that metadata of the next song track contains a particular PAL notice. According to at least one other embodiment, dynamic adjustment of one or more equalizer settings (e.g., bass, treble, and/or mid-range) of the wireless speaker may be achieved by DCC program 107 determining that metadata of a next or currently playing song indicates that the song belongs to a particular genre. For example, DCC program 107 may automatically reduce the maximum bass value of the wireless speaker in response to determining that a currently playing song belongs to a hip-hop or hard-rock genre.

As mentioned above, the created one or more secondary control profiles may include one or more user-specific secondary control profiles for the wireless speaker. A user-specific secondary control profile may be created for a non-owning or non-administrative user who is connecting to the wireless speaker via their smart device (e.g., smartphone) which is known to DCC program 107. An example of a user-specific secondary control profile for a non-owning or non-administrative user is depicted in Table 3 below:

TABLE 3

| PARAMETER | VALUE |
|---|---|
| Profile Name/Type | user-1 |
| Smart Device ID | smartphone-1 |
| Smart Device Authority Level | secondary |
| Audio Device Maximum Volume | 80% |
| Audio Device Maximum Bass | 70% |
| Audio Device Maximum Treble | 70% |
| Audio Device Maximum Mid-Range | 70% |
| Audio Device Operating Hours | 6:00am- |
| | 2:00am |
| Operating Hours Maximum Volume | 10:00pm- |
| | 2:00am \| 60% |
| Dynamic Lyric Lookup | on |
| Deny List Capability | on |
| Deny List Contents | lyrics: explicit |

As can be seen in Table 3, the user-specific secondary control profile may define the profile name/type as being a user-specific name (e.g., user-1), identify a smart phone of the non-owning or non-administrative user by some specific ID (e.g., smartphone-1) of the smart phone, set an authority level of the smart phone to secondary (i.e., a level of authority lacking ability to change parameter values), limit maximum volume of the wireless speaker to 80%, limit maximum values for bass, treble, and mid-range of the wireless speaker to 70%, limit operating hours of the wireless speaker (and further limit the maximum volume during a subset of the operating hours), enable dynamic lyric lookup, and enable deny list capability based on deny list contents. Furthermore, DCC program 107 may correlate the created user-specific secondary control profile with the smartphone of the non-owning or non-administrative user by correlating the smart device ID of the smartphone with the profile name/type. Furthermore, DCC program 107 may store the created user-specific secondary control profile within storage 124 or remote database 130. According to at least one embodiment, upon subsequent connections to the wireless speaker by the non-owning or non-administrative user via their smartphone, DCC program 107 may retrieve the correlated user-specific secondary control profile from storage 124 or remote database 130 and operate the wireless speaker accordingly.

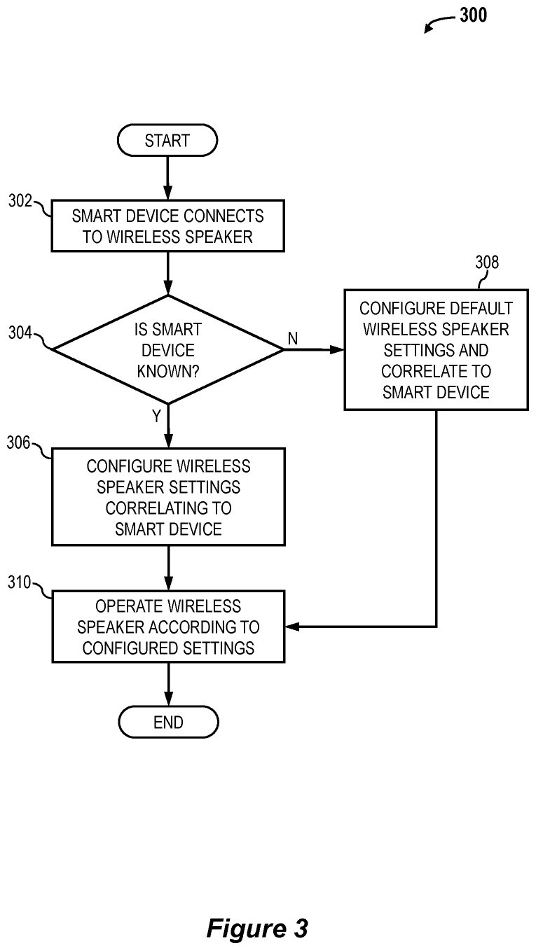

Referring now to FIG. 3, an operational flowchart for configuring operation of a wireless speaker by a user via a wireless audio device operation process 300 is depicted according to at least one embodiment. At 302, a user of a wireless audio device, such as a wireless speaker, connects to the wireless speaker via their smart device, such as their smartphone, which they intend to use to control operation of the wireless speaker. The user of the wireless speaker may have installed DCC program 107 on their smartphone prior to connecting to the wireless speaker. Alternatively, the user of the wireless speaker may be prompted to install DCC program 107 on their smartphone and accept wireless audio device management by DCC program 107 upon initial connection to the wireless speaker. Connection between the smartphone of the user and the wireless speaker may be implemented via a wireless connectivity protocol such as Z-wave, Bluetooth, or Wi-Fi.

Next, at 304, DCC program 107 determines whether the connected smart device (e.g., smartphone) of the user is known. In making this determination, DCC program 107 may identify a smart device ID of the smartphone and reference created control profiles stored within storage 124 or remote database 130 to determine if the identified smart device ID of the smartphone is correlated to a stored control profile. According to at least one embodiment, a connected smartphone may be known to DCC program 107 where an identified smart device ID of the smartphone is correlated with a created primary or secondary control profile. Further, a connected smartphone may not be known to DCC program 107 where an identified smart device ID of the smartphone is not correlated with a created primary or secondary control profile or where the smart device ID of the smartphone is unidentified (i.e., unknown). In response to determining that the connected smartphone of the user is known (step 304, “Y” branch), the wireless audio device operation process 300 may proceed to step 306. In response to determining that the connected smartphone of the user is not known (step 304, “N” branch), the wireless audio device operation process 300 may proceed to step 308.

According to at least one other embodiment, in response to a non-owning or non-administrative user connecting to the wireless speaker via a known smart device or in response to an unknown smart device connecting to the wireless speaker, DCC program 107 may send a notification of connection to an instance of DCC program 107 executing on a smart device (e.g., smartphone) of an owning or administrative user of the wireless speaker. DCC program 107 may prompt the owning or administrative user for authorization of the connection before allowing the known or unknown smart device to further interact with the wireless speaker. Where authorization of the connection is not received, DCC program 107 may disable the connection of the known or unknown smart device and/or lock operation of the wireless speaker until authorization is received from the owning or administrative user. According to at least one further embodiment, an owning or administrative user of a wireless audio device may control network discoverability of the wireless audio device and limit connections to the audio device to only known or designated smart devices.

At 306, in response to determining that the connected smartphone of the user is known, DCC program 107 configures operation of the wireless speaker according to settings correlating to the connected smartphone. More specifically, DCC program 107 configures operation of the wireless speaker according to settings of a control profile which is correlated to the smartphone. For example, if the smartphone is correlated to a stored secondary control profile (e.g., a stored user-specific secondary control profile, as described above), DCC program 107 may allow operation of the wireless speaker by the smartphone according to parameters defined in the correlated secondary control profile. Likewise, if the smartphone is correlated to a stored primary control profile, as described above, DCC program 107 may allow operation of the wireless speaker by the smartphone according to parameters defined in the correlated primary control profile.

At 308, in response to determining that the connected smartphone of the user is not known, DCC program 107 configures operation of the wireless speaker according to default settings and correlates those settings to the connected smartphone. More specifically, DCC program 107 configures operation of the wireless speaker according to settings of a created default secondary control profile and correlates the default secondary control profile with the connected smartphone of the user. For example, DCC program 107 may allow operation of the wireless speaker by the smartphone according to parameters defined in the created default secondary control profile described above.

Next, at 310, DCC program 107 allows operation of the wireless speaker, by the connected smart device, according to configured settings. More specifically, where the connected smartphone of the user is known, DCC program 107 may allow the connected smartphone to operate the wireless speaker according to parameters defined in the correlated control profile (e.g., the correlated primary control profile or the correlated user-specific secondary control profile). Likewise, where the connected smartphone of the user is not known, DCC program 107 may allow the connected smartphone to operate the wireless speaker according to parameters defined in the correlated default secondary control profile. By managing operation of the wireless speaker based on the user, via their controlling smart device, being known or unknown, DCC program 107 may allow for more granular user-specific configuration and use of the wireless speaker instead of enforcing global configurations and uses across all users of the wireless speaker.

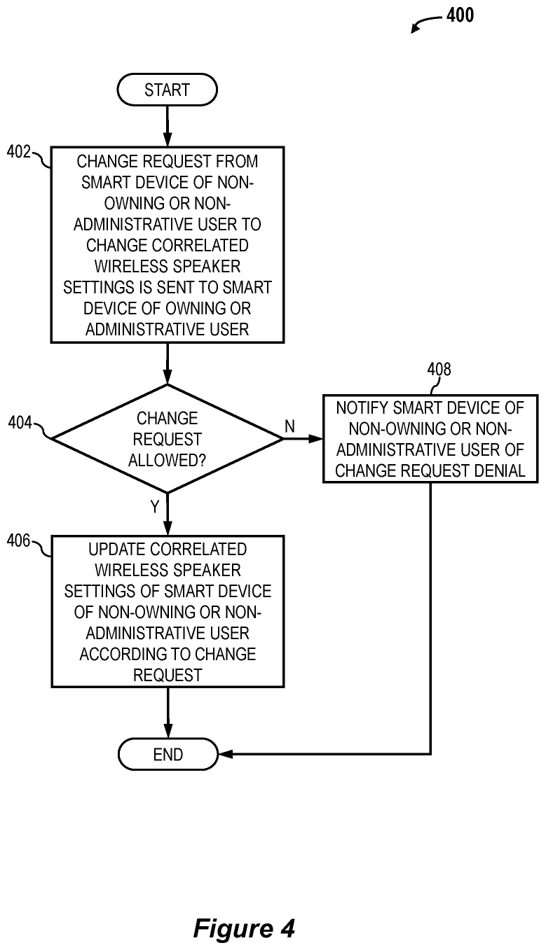

Referring now to FIG. 4, an operational flowchart for requesting a change to correlated wireless speaker settings of a user via a wireless audio device settings change request process 400 is depicted according to at least one embodiment. At 402, a change request from an instance of DCC program 107 executing on a smartphone of a non-owning or non-administrative user of a wireless speaker to change one or more wireless speaker settings which are correlated with the smartphone of the non-owning or non-administrative user is sent to an instance of DCC program 107 executing on a smartphone of an owning or administrative user of the wireless speaker. For example, the non-owning or non-administrative user may wish to increase the audio device maximum volume parameter and the audio device operation hours parameter of the user-specific secondary control profile correlated with their smartphone to 90% and 6:00 am-4:00 am, respectively, and, accordingly, request such changes from the owning or administrative user of the wireless speaker who may receive a detailed notification of the change request via their respective smartphone.

Next, at 404, the owning or administrative user, via the instance of DCC program 107 executing on their smartphone, determines whether to allow or deny the change request of the non-owning or non-administrative user. In making this determination, the instance of DCC program 107 executing on the owning or administrative user's smartphone may display, via a display of the smartphone, details of the secondary control profile correlated with the smartphone of the non-owning or non-administrative user. In response to determining to allow the change request (step 404, “Y” branch), the wireless audio device settings change request process 400 may proceed to step 406. In response to determining to not allow the change request (step 404, “N” branch), the wireless audio device settings change request process 400 may proceed to step 408. According to at least one other embodiment, in a scenario where the change request includes changes to a plurality of parameters of a control profile, the owning or administrative user, via the instance of DCC program 107 executing on their smartphone, may determine to allow one or more parameters of change request and deny one or more other parameters of the change request.

At 406, in response to determining to allow the change request, DCC program 107 updates the wireless speaker settings which are correlated with the smartphone of the non-owning or non-administrative user according to the details of the change request. For example, in response to determining to allow the requested increases to audio device maximum volume and audio device operation hours, DCC program 107 may update those parameters of the user-specific secondary control profile correlated with the smartphone of the non-owning or non-administrative user according to the details of the change request. Furthermore, the instance of DCC program 107 executing on the smartphone of the non-owning or non-administrative user may receive a notification of the change request allowance and display details of the notification to the non-owning or non-administrative user via a display of their smartphone.

At 408, in response to determining to not allow the change request, DCC program 107 sends a notification of change request denial to the smartphone of the non-owning or non-administrative user. The notification may be displayed to the non-owning or non-administrative user via a display of their smartphone and may communicate details of the denial.

It may be appreciated that FIGS. 2, 3, and 4 provide only an illustration of one implementation and does not imply any limitations with regard to how different embodiments may be implemented. Many modifications to the depicted environments may be made based on design and implementation requirements.

According to at least one embodiment, the present invention may be realized by the inclusion of logic and processing on the wireless audio device (e.g., wireless speaker) itself which may be capable of storing control profile information of respective smart devices (e.g., smartphones) of individual users, correlating data for a smart device and/or individual user with either a default or user-specific control profile to be enforced, and enabling settings of a control profile on the speaker device. Manual control of volume and/or equalizer settings via buttons on a wireless speaker itself or on a separate remote control may also be managed by the present invention.

According to at least one other embodiment, further integration of the present invention with voice recognition may be realized when using third-party devices for control such as a smart speaker. In this circumstance, voice recognition may be performed on the third-party device and correlated with a known user, user information and control requests may then be forwarded to DCC program 107. For example, user-1 asking a smart speaker, “play salsa music on wireless speaker”, may result in the smart speaker identifying the voice as that of user-1 and sending the name and command to an instance of DCC program 107 for user-1 or to the wireless speaker itself if considering an embodiment in which the logic of DCC program 107 is contained within the wireless speaker itself. DCC program 107 may correlate the name with an existing control profile and enable the associated settings. This may also happen on the third-party device itself if it is being used as the speaker and an embodiment of the present invention is incorporated into the third-party device.

According to at least one further embodiment, control profile information correlated with a smart device of a user may be transferred across multiple wireless audio devices (e.g., wireless speakers, smart TVs) automatically. As such, when a new wireless audio device is introduced to a network, control profiles correlated with authorized/known smart devices of respective users may be automatically transferred to the new wireless audio device thus requiring no further configuration.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
connecting to a wireless audio device via a smart device of a non-owner user of the wireless audio device, wherein the wireless audio device operates according to a plurality of control profiles;
in response to determining that an identification (ID) the smart device correlates to a user-specific secondary control profile of the plurality of control profiles, enabling operation of the wireless audio device by the smart device according to the user-specific secondary control profile; and
in response to determining that the ID of the smart device does not correlate to any user-specific secondary control profiles of the plurality of control profiles, enabling operation of the wireless audio device by the smart device according to a default secondary control profile of the plurality of control profiles.

2. The method of claim 1, further comprising:
connecting to the wireless audio device via a smart device of an owning user of the wireless audio device;
creating a primary control profile of the plurality of control profiles, wherein the primary control profile enables unrestricted operation of the wireless audio device;
correlating the primary control profile with the smart device of the owning user;
creating one or more secondary control profiles of the plurality of control profiles, wherein the one or more secondary control profiles comprises one or more user-specific secondary control profiles and at least one default secondary control profile, and wherein the primary control profile has a higher level of wireless audio device authority than the one or more secondary control profiles; and
correlating the one or more user-specific secondary control profiles with respective smart devices of non-owner users of the wireless audio device.

3. The method of claim 1, wherein the user-specific secondary control profile and the default secondary control profile respectively define a set of parameters, and corresponding values, according to which the wireless audio device operates, and wherein the set of parameters comprises profile name/type, smart device identification (ID), smart device authority level, audio device maximum volume, audio device maximum bass, audio device maximum treble, audio device maximum mid-range, audio device operating hours, operating hours maximum volume, dynamic lyric lookup, deny list capability, and deny list contents.

4. The method of claim 1, wherein control profiles of the plurality of control profiles respectively allow for dynamic lyric lookup of songs to be played on the wireless audio device, and wherein dynamic lyric lookup comprises:
querying known sources of song track information for lyrics of a next song as well as for metadata information of the next song, and wherein metadata information comprises song title, artist name, song genre, and any parental advisory label (PAL) notices for a song;
determining if the next song meets criteria to not be played on the wireless audio device based on the lyrics of the next song and the metadata information of the next song; and
in response to determining that the next song meets criteria to not be played on the wireless audio device, adding a song title of the next song a deny list of a control profile, wherein songs having their title on the deny list are not played by the wireless audio device.

5. The method of claim 4, wherein control profiles of the plurality of control profiles respectively allow for dynamic adjustment of one or more equalizer settings of the wireless audio device during playback of songs on the wireless audio device, and wherein dynamic adjustment of one or more equalizer settings comprises:
determining that a currently playing song on the wireless audio device belongs to a particular genre based on metadata information of the currently playing song; and
reducing one or more equalizer settings of the wireless audio device during playback of the currently playing song.

6. The method of claim 2, further comprising:
receiving, at the smart device of the owning user of the wireless audio device, a change request to change one or more settings of the user-specific secondary control profile correlating to the smart device of the non-owner user;
in response to a determination to allow the change request, updating the one or more settings of the user-specific secondary profile according to the change request and notifying the smart device of the non-owner user of the updating; and
in response to a determination to not allow the change request, notifying the smart device of the non-owner user of the determination to not allow the change request.

7. The method of claim 1, wherein the wireless audio device comprises a wireless speaker.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
connecting to a wireless audio device via a smart device of a non-owner user of the wireless audio device, wherein the wireless audio device operates according to a plurality of control profiles;
in response to determining that an identification (ID) the smart device correlates to a user-specific secondary control profile of the plurality of control profiles, enabling operation of the wireless audio device by the smart device according to the user-specific secondary control profile; and
in response to determining that the ID of the smart device does not correlate to any user-specific secondary control profiles of the plurality of control profiles, enabling operation of the wireless audio device by the smart device according to a default secondary control profile of the plurality of control profiles.

9. The computer system of claim 8, further comprising:
connecting to the wireless audio device via a smart device of an owning user of the wireless audio device;
creating a primary control profile of the plurality of control profiles, wherein the primary control profile enables unrestricted operation of the wireless audio device;
correlating the primary control profile with the smart device of the owning user;
creating one or more secondary control profiles of the plurality of control profiles, wherein the one or more secondary control profiles comprises one or more user-specific secondary control profiles and at least one default secondary control profile, and wherein the primary control profile has a higher level of wireless audio device authority than the one or more secondary control profiles; and
correlating the one or more user-specific secondary control profiles with respective smart devices of non-owner users of the wireless audio device.

10. The computer system of claim 8, wherein the user-specific secondary control profile and the default secondary control profile respectively define a set of parameters, and corresponding values, according to which the wireless audio device operates, and wherein the set of parameters comprises profile name/type, smart device identification (ID), smart device authority level, audio device maximum volume, audio device maximum bass, audio device maximum treble, audio device maximum mid-range, audio device operating hours, operating hours maximum volume, dynamic lyric lookup, deny list capability, and deny list contents.

11. The computer system of claim 8, wherein control profiles of the plurality of control profiles respectively allow for dynamic lyric lookup of songs to be played on the wireless audio device, and wherein dynamic lyric lookup comprises:
querying known sources of song track information for lyrics of a next song as well as for metadata information of the next song, and wherein metadata information comprises song title, artist name, song genre, and any parental advisory label (PAL) notices for a song;
determining if the next song meets criteria to not be played on the wireless audio device based on the lyrics of the next song and the metadata information of the next song; and
in response to determining that the next song meets criteria to not be played on the wireless audio device, adding a song title of the next song a deny list of a control profile, wherein songs having their title on the deny list are not played by the wireless audio device.

12. The computer system of claim 11, wherein control profiles of the plurality of control profiles respectively allow for dynamic adjustment of one or more equalizer settings of the wireless audio device during playback of songs on the wireless audio device, and wherein dynamic adjustment of one or more equalizer settings comprises:
determining that a currently playing song on the wireless audio device belongs to a particular genre based on metadata information of the currently playing song; and
reducing one or more equalizer settings of the wireless audio device during playback of the currently playing song.

13. The computer system of claim 9, further comprising:
receiving, at the smart device of the owning user of the wireless audio device, a change request to change one or more settings of the user-specific secondary control profile correlating to the smart device of the non-owner user;
in response to a determination to allow the change request, updating the one or more settings of the user-specific secondary profile according to the change request and notifying the smart device of the non-owner user of the updating; and
in response to a determination to not allow the change request, notifying the smart device of the non-owner user of the determination to not allow the change request.

14. The computer system of claim 8, wherein the wireless audio device comprises a wireless speaker.

15. A computer program product, the computer program product comprising:
one or more computer-readable tangible storage medium and program instructions stored on at least one of the one or more tangible storage medium, the program instructions executable by a processor capable of performing a method, the method comprising:
connecting to a wireless audio device via a smart device of a non-owner user of the wireless audio device, wherein the wireless audio device operates according to a plurality of control profiles;
in response to determining that an identification (ID) the smart device correlates to a user-specific secondary control profile of the plurality of control profiles, enabling operation of the wireless audio device by the smart device according to the user-specific secondary control profile; and
in response to determining that the ID of the smart device does not correlate to any user-specific secondary control profiles of the plurality of control profiles, enabling operation of the wireless audio device by the smart device according to a default secondary control profile of the plurality of control profiles.

16. The computer program product of claim 15, further comprising:
connecting to the wireless audio device via a smart device of an owning user of the wireless audio device;
creating a primary control profile of the plurality of control profiles, wherein the primary control profile enables unrestricted operation of the wireless audio device;
correlating the primary control profile with the smart device of the owning user;
creating one or more secondary control profiles of the plurality of control profiles, wherein the one or more secondary control profiles comprises one or more user-specific secondary control profiles and at least one default secondary control profile, and wherein the primary control profile has a higher level of wireless audio device authority than the one or more secondary control profiles; and
correlating the one or more user-specific secondary control profiles with respective smart devices of non-owner users of the wireless audio device.

17. The computer program product of claim 15, wherein the user-specific secondary control profile and the default secondary control profile respectively define a set of parameters, and corresponding values, according to which the wireless audio device operates, and wherein the set of parameters comprises profile name/type, smart device identification (ID), smart device authority level, audio device maximum volume, audio device maximum bass, audio device maximum treble, audio device maximum mid-range, audio device operating hours, operating hours maximum volume, dynamic lyric lookup, deny list capability, and deny list contents.

18. The computer program product of claim 15, wherein control profiles of the plurality of control profiles respectively allow for dynamic lyric lookup of songs to be played on the wireless audio device, and wherein dynamic lyric lookup comprises:
querying known sources of song track information for lyrics of a next song as well as for metadata information of the next song, and wherein metadata information comprises song title, artist name, song genre, and any parental advisory label (PAL) notices for a song;
determining if the next song meets criteria to not be played on the wireless audio device based on the lyrics of the next song and the metadata information of the next song; and
in response to determining that the next song meets criteria to not be played on the wireless audio device, adding a song title of the next song a deny list of a control profile, wherein songs having their title on the deny list are not played by the wireless audio device.

19. The computer program product of claim 18, wherein control profiles of the plurality of control profiles respectively allow for dynamic adjustment of one or more equalizer settings of the wireless audio device during playback of songs on the wireless audio device, and wherein dynamic adjustment of one or more equalizer settings comprises:
determining that a currently playing song on the wireless audio device belongs to a particular genre based on metadata information of the currently playing song; and
reducing one or more equalizer settings of the wireless audio device during playback of the currently playing song.

20. The computer program product of claim 16, further comprising:
receiving, at the smart device of the owning user of the wireless audio device, a change request to change one or more settings of the user-specific secondary control profile correlating to the smart device of the non-owner user;
in response to a determination to allow the change request, updating the one or more settings of the user-specific secondary profile according to the change request and notifying the smart device of the non-owner user of the updating; and
in response to a determination to not allow the change request, notifying the smart device of the non-owner user of the determination to not allow the change request.
